(19) United States
(12) Patent Application Publication
(10) Pub. No.: US 2025/0208849 A1
(43) Pub. Date: Jun. 26, 2025

(54) SETTINGS OR FIRMWARE VALIDATION FOR POWER DELIVERY SYSTEM USING POWER DELIVERY SYSTEM VALUES BEFORE AND AFTER SETTINGS OR FIRMWARE CHANGE

(71) Applicant: Schweitzer Engineering Laboratories, Inc., Pullman, WA (US)

(72) Inventors: Javier Fernando D'Acosta, San Juan Capistrano, CA (US); David J. Dolezilek, Pullman, WA (US)

(73) Assignee: Schweitzer Engineering Laboratories, Inc., Pullman, WA (US)

(21) Appl. No.: 18/394,253

(22) Filed: Dec. 22, 2023

(51) Int. Cl. G06F 8/65

(52) U.S. Cl. CPC G06F 8/65

(57) ABSTRACT

Systems and methods to validating a settings file or firmware update of an intelligent electronic device (IED) of an electric power delivery system are provided. A system may include a computing device that communicatively couples to an intelligent electronic device (IED) of an electric power delivery system. The computing device may receive a first signal indicative of first measurements including first internal logic results from the intelligent electronic device (IED), transmit a second signal indicative of instructions to pause normal intelligent electronic device (IED) operation and apply a settings file or firmware update, and receive a third signal indicative of second measurements including second internal logic results from the intelligent electronic device (IED). The computing device may then determine validation of the settings file or firmware update based on the first measurements and the second measurements.

### BACKGROUND

This disclosure relates to systems and methods for remotely validating a firmware update or configuration changes of an intelligent electronic device (IED) of an electric power delivery system based on records of device interaction with power delivery system values before and after changes.

This section is intended to introduce the reader to various aspects of art that may be related to various aspects of the present techniques, which are described and/or claimed below. This discussion is believed to be helpful in providing the reader with background information to facilitate a better understanding of the various aspects of the present disclosure. Accordingly, it should be understood that these statements are to be read in this light, and not as admissions of any kind.

Electric power delivery systems carry electricity from a transmission system to residential communities, factories, industrial areas, and other electricity consumers. An electric power delivery system may include various intelligent electronic devices (IEDs) that may communicate with other devices of the electric power delivery system during operation of the electric power delivery system. For example, an IED may receive and/or transmit a signal and/or data in order to perform a control function, such as to control a circuit breaker in response to electrical measurements of the electric power distribution system. In some cases, updates to these devices may be performed and validated on-site by a technician, but this process is difficult and time consuming when devices are numerous or remote.

### BRIEF DESCRIPTION OF THE DRAWINGS

FIG. 1 is a schematic diagram of an electric power delivery system;

FIG. 2 is a block diagram of a computing system of the electric power delivery system;

FIG. 3A is a block diagram illustrating an operation to obtain intelligent electronic device (IED) measurements of the electric power delivery system;

FIG. 3B is a block diagram illustrating the system of FIG. 3A, in which a computing device receives digitized values from a merging unit and measurements from an IED generated based on the digitized values;

FIG. 3C is a block diagram illustrating the system of FIG. 3A, in which an IED generates IED measurements based on simulated digitized values;

FIG. 3D is a block diagram illustrating the system of FIG. 3A, in which a testing device generates simulated digitized values based on a test file;

FIG. 3E is a block diagram illustrating the system of FIG. 3A, in which a testing device generates simulated analog system values based on a test file;

FIG. 4 is a flowchart of a method for updating firmware of the IED and testing the firmware using recorded measurements;

FIG. 5 is a block diagram illustrating an operation to update the firmware of the IED;

FIG. 6 is a block diagram illustrating an operation to test the updated firmware of the IED using recorded measurements;

FIG. 7 is a block diagram illustrating an operation to remotely update the firmware of the IED via a wide area network (WAN); and

FIG. 8 is a block diagram illustrating an operation to remotely test the updated firmware of the IED using recorded measurements provided via a wide area network (WAN).

### DETAILED DESCRIPTION

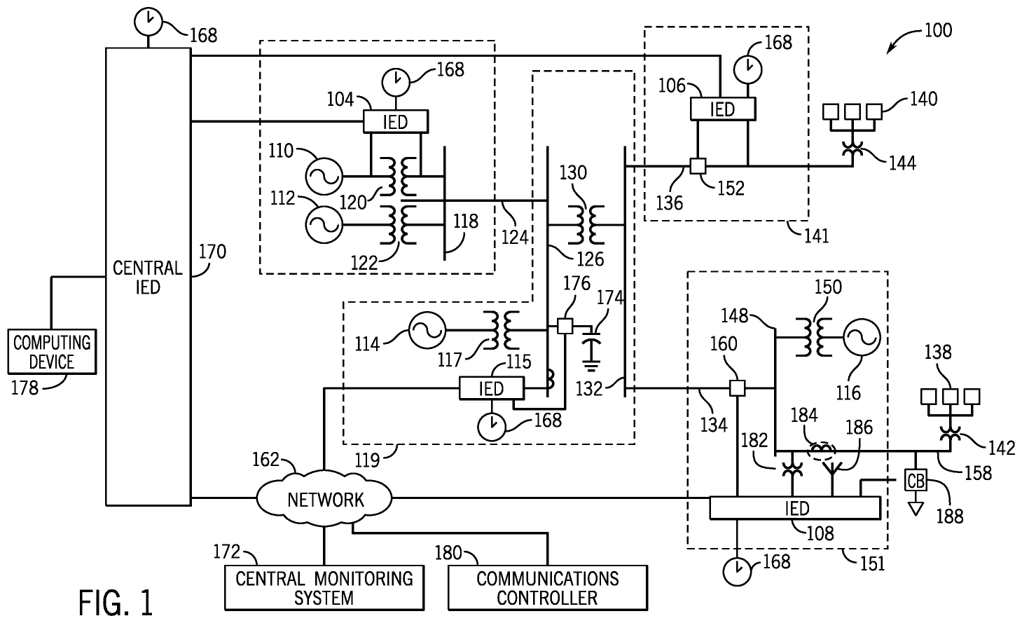

Turning to the drawings, FIG. 1 is a schematic diagram of an electric power distribution system 100 that may generate, transmit, and/or distribute electric energy to various loads (e.g., different structures). The electric power distribution system 100 may use various IEDs 104, 106, 108, 115 to control certain aspects of the electric power distribution system 100. As used herein, an IED (e.g., the IEDs 104, 106, 108, 115) may refer to any processing-based device that monitors, controls, automates, and/or protects monitored equipment within the electric power distribution system 100. Although the present disclosure primarily discusses the IEDs 104, 106, 108, 115 as relays, such as a differential relay, a distance relay, a directional relay, a feeder relay, an overcurrent relay, a voltage regulator control, a voltage relay, a breaker failure relay, a generator relay, and/or a motor relay, additional IEDs 104, 106, 108, 115 may include an automation controller, a bay controller, a meter, a recloser control, a communications processor, a computing platform, a remote terminal unit, a programmable logic controller (PLC), a programmable automation controller, an input and output module, and the like. Moreover, the term IED may be used to describe an individual IED or a system including multiple IEDs.

For example, the electric power distribution system 100 may be monitored, controlled, automated, and/or protected using the IEDs 104, 106, 108, 115, and a central monitoring system 172 (e.g., an industrial control system). In general, the IEDs 104, 106, 108, 115 may be used for protection, control, automation, and/or monitoring of equipment in the electric power distribution system 100. For example, the IEDs 104, 106, 108, 115 may be used to monitor equipment of many types, including electric power lines, electric power lines, current sensors, busses, switches, circuit breakers, reclosers, transformers, autotransformers, tap changers, voltage regulators, capacitor banks, generators, motors, pumps, compressors, valves, and a variety of other suitable types of monitored equipment.

A common time signal may be distributed throughout the electric power distribution system 100. Utilizing a common time source may ensure that IEDs 104, 106, 108, 115 have a synchronized time signal that can be used to generate time synchronized data, such as synchrophasors. In various embodiments, the IEDs 104, 106, 108, 115 may receive a common time signal 168. The time signal may be distributed in the electric power distribution system 100 using a communications network 162 and/or using a common time source, such as a Global Navigation Satellite System (“GNSS”), or the like.

The IEDs 104, 106, 108, 115 may be used for controlling various other equipment of the electric power distribution system 100. By way of example, the illustrated electric power distribution system 100 includes electric generators 110, 112, 114, 116 and power transformers 117, 120, 122, 130, 142, 144, 150. The electric power distribution system 100 may also include electric power lines 124, 134, 136, 158 and/or busses 118, 126, 132, 148 to transmit and/or deliver power, circuit breakers 152, 160, 176 to control flow of power in the electric power distribution system 100, and/or loads 138, 140 to receive the power in and/or from the electric power distribution system 100. A variety of other types of equipment may also be included in electric power distribution system 100, such as a voltage regulator, a capacitor (e.g., a capacitor 174), a potential transformer (e.g., a potential transformer 182), a current sensor (e.g., a wireless current sensor (WCS) 184), an antenna (e.g., an antenna 186), a capacitor banks (e.g., a capacitor bank (CB) 188), and other suitable types of equipment useful in power generation, transmission, and/or distribution.

A substation 119 may include the electric generator 114, which may be a distributed generator and which may be connected to the bus 126 through the power transformer 117 (e.g., a step-up transformer). The bus 126 may be connected to the distribution bus 132 via the power transformer 130 (e.g., a step-down transformer). Various electric power lines 136, 134 may be connected to the distribution bus 132. The electric power line 136 may lead to a substation 141 in which the electric power line 136 is monitored and/or controlled using the IED 106, which may selectively open and close the circuit breaker 152. The load 140 may be fed from the electric power line 136, and the power transformer 144 (e.g., a step-down transformer) in communication with the distribution bus 132 via electric power line 136 may be used to step down a voltage for consumption by the load 140.

The electric power line 134 may deliver electric power to the bus 148 of the substation 151. The bus 148 may also receive electric power from the distributed electric generator 116 via the power transformer 150. The electric power line 158 may deliver electric power from the bus 148 to the load 138 and may include the power transformer 142 (e.g., a step-down transformer). The circuit breaker 160 may be used to selectively connect the bus 148 to the electric power line 134. The IED 108 may be used to monitor and/or control the circuit breaker 160 as well as the electric power line 158.

According to various embodiments, the central monitoring system 172 may include one or more of a variety of types of systems. For example, the central monitoring system 172 may include a supervisory control and data acquisition (SCADA) system and/or a wide area control and situational awareness (WACSA) system. A central IED 170 may be in communication with the IEDs 104, 106, 108, 115. The IEDs 104, 106, 108, 115 may be remote from the central IED 170 and may communicate over various media. For instance, the central IED 170 may be directly in communication with the IEDs 104, 106 and may be in communication with the IEDs 108, 115 via the communications network 162.

The central IED 170 may enable or block data flow between any of the IEDs 104, 106, 108, 115. For example, during operation of the electric power distribution system 100, the IEDs 104, 106, 108, 115 may transmit data to one another to perform various functionalities for the electric power distribution system 100 by initially transmitting the data to the central IED 170. The central IED 170 may receive the data and may subsequently transmit the data to an intended recipient of the data. The central IED 170 may also control data flow between one of the IEDs 104, 106, 108, 115 and another device communicatively coupled to the central IED 170, such as a computing device 178. For instance, the computing device 178 may be a laptop, a mobile phone, a desktop, a tablet, or another suitable device with which a user (e.g., a technician, an operator) may interact. As such, the user may utilize the computing device 178 to receive data, such as operating data, from the electric power distribution system 100 via the central IED 170 and/or to send data, such as a user input, to the electric power distribution system 100 via the central IED 170. Thus, the central IED 170 may enable or block operation of the electric power distribution system 100 via the computing device 178.

A communications controller 180 may interface with equipment in the communications network 162 to create an SDN that facilitates communication between the central IED 170, the IEDs 104, 106, 108, 115, and/or the central monitoring system 172. In various embodiments, the communications controller 180 may interface with a control plane (not shown) in the communications network 162. Using the control plane, the communications controller 180 may direct the flow of data within the communications network 162. Indeed, the communications controller 180 may communicate with the central IED 170 to instruct the central IED 170 to transmit certain data (e.g., data associated with a certain set of characteristics or information) to a particular destination (e.g., an intended recipient) using flows, matches, and actions defined by the communications controller 180.

It may be desirable to adjust (e.g., update) the firmware of the central IED 170 and/or the IEDs 104, 106, 108, 115, and validate that the adjusted firmware works properly. For example, it may be desirable to adjust a variable or property of an IED to change how the IED performs a control function. Thus, embodiments of the present disclosure are directed to simplifying the manner in which the configuration of an IED may be adjusted and validated.

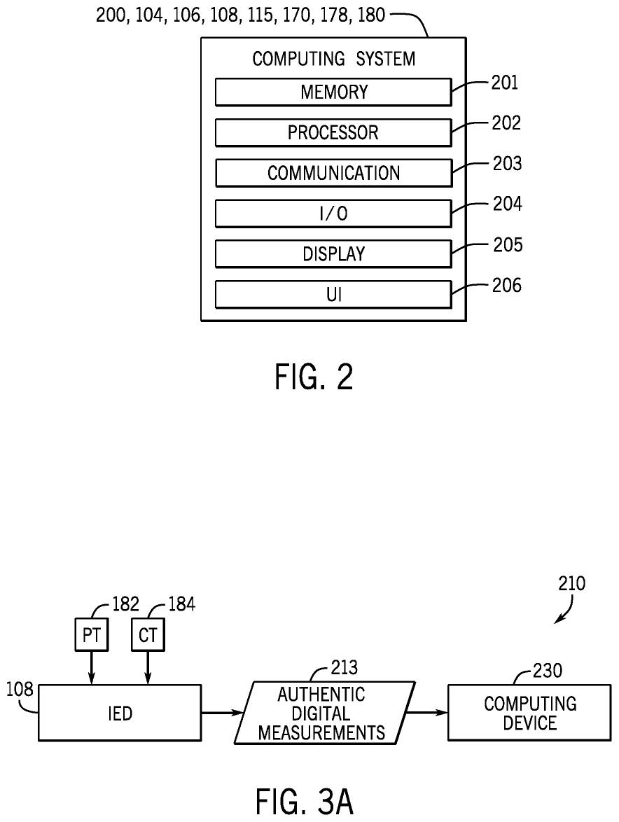

FIG. 2 is a schematic diagram of an example of a computing system 200 that may be incorporated within a device of the electric power distribution system 100, such as in any of the IEDs 104, 106, 108, 115, the central IED 170, the computing device 178, and/or the communications controller or key device or 180. The computing system 200 may include a memory 201 and a processor or processing circuitry (e.g., data processing circuitry) 202. The memory 201 may include a non-transitory computer-readable medium that may store instructions that, when executed by the processor 202, may cause the processor 202 to perform various methods and/or operations described herein. To this end, the processor 202 may be any suitable type of computer processor or microprocessor capable of executing computer-executable code, including but not limited to one or more field programmable gate arrays (FPGA), application-specific integrated circuits (ASIC), programmable logic devices (PLD), programmable logic arrays (PLA), and the like. The processor 202 may include a single processor core or multiple processor cores.

The computing system 200 may also include a communication system 203, which may include a wireless and/or wired communication device to establish a secure communication link with another device of the electric power distribution system 100. That is, the communication system 203 enables the computing system 200 (e.g., of one of the IEDs 104, 106, 108, 115) to communicate with another communication system 203 of another computing system 200 (e.g., of the central IED 170), using methods such as via MACsec. Indeed, the communication system 203 may include any suitable communication circuitry for communication via a personal area network (PAN), such as Bluetooth or ZigBee, a local area network (LAN) or wireless local area network (WLAN), such as an 802.11x Wi-Fi network, and/or a wide area network (WAN), (e.g., third-generation (3G) cellular, fourth-generation (4G) cellular, near-field communications technology, universal mobile telecommunication system (UMTS), long term evolution (LTE), long term evolution license assisted access (LTE-LAA), fifth-generation (5G) cellular, and/or 5G New Radio (5G NR) cellular). The communication system 203 may also include a network interface to enable communication via various protocols such as EtherNet/IP®, ControlNet®, DeviceNet®, or any other suitable industrial communication network protocol.

Additionally, the computing system 200 may include input/output (I/O) ports 204 that may be used for communicatively coupling the computing system 200 to an external device. For example, the I/O ports 204 of the computing system 200 of the central IED 170 may communicatively couple to corresponding I/O ports 204 of the computing system 200 of the computing device 178. The computing system 200 may further include a display 205 that may present any suitable image data or visualization. Indeed, the display 205 may present image data that includes various information regarding the electric power distribution system 100, thereby enabling the user to observe an operation, a status, a parameter, other suitable information, or any combination thereof, of the electric power distribution system 100. Further still, the computing system 200 may include a user interface (UI) 206 with which the user may interact to control an operation of the computing system 200. For instance, the UI 206 may include a touch screen (e.g., as a part of the display 205), an eye-tracking sensor, a gesture (e.g., hand) tracking sensor, a joystick or physical controller, a button, a knob, a switch, a dial, a trackpad, a mouse, another component, or any combination thereof. As an example, the user may utilize the UI 206 of the computing system 200 of the computing device 178 to transmit data to the central IED 170.

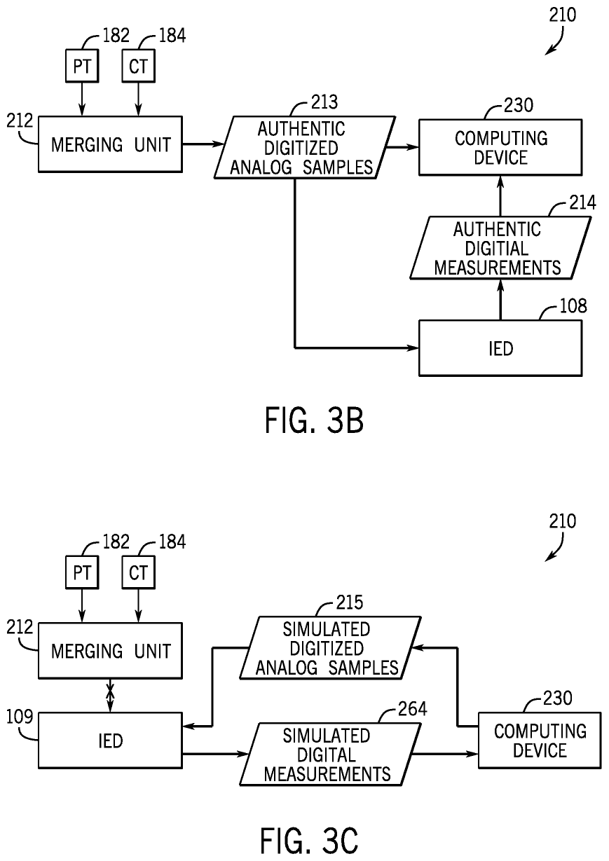

FIG. 3A is a schematic block diagram illustrating a system 210 in which IED measurements are recorded during normal operation. Normal operation of the IED 108 may include, for example, receiving electric power delivery system values from a potential transformer 182 and making logic decisions and/or controlling one or more components of the electric power delivery system, such as a circuit breaker, based on the electric power delivery system values. A potential transformer 182 and a current transformer 184 may be connected to an electrical power line of an electric power delivery system to monitor power system values (e.g., current, voltage, etc.) of the electric power delivery system. The potential transformer 182 and current transformer 184 may convert (e.g., reduce, scale, or otherwise alter) the power system values to a range determined to be interpretable by an IED 108. In the illustrated example, the IED 108 may receive the power system values from the potential transformer 182 and the current transformer 184. The IED 108 may convert the received power system values to digital data, may perform internal logic, and may act as a merging unit to transmit the digital data to another IED, and making logic decisions and/or controlling one or more components of the electric power delivery system, and a computing device 230 as authentic digital measurements 214. The computing device 230 may, over a specified or determined period of time, record the authentic digital measurements 214 it receives from the IED 108 and collect records of the internal logic performed by the IED 108 and store them in memory. This operation may be performed prior to a settings change (e.g., configuration change) or an update or change to the firmware of the IED 108, allowing characterization of the behavior of the IED 108 during normal operation. The computing device 230 may, over a specified or determined period of time, record the authentic digital measurements 214 it receives from the IED 108 (e.g., when the IED 108 includes a relay) and/or digitized values from IED 108 (e.g., when the IED 108 includes a merging unit) and collect records of the internal logic performed by the IED 108 and store them in memory. This operation may be performed prior to a settings change (e.g., configuration change) or an update or change to the firmware of the IED 170, allowing characterization of the behavior of the IED 170 during normal operation. [The computing device 230 may, over a specified or determined period of time, record the authentic digital measurements 214 it receives from the IED 108 acting as a relay and/or digitized values from IED 108 acting as a merging unit, and collect records of the internal logic performed by the IED 108 and store them in memory. This operation may be performed prior to a settings change (e.g., configuration change) or an update or change to the firmware of the IED 108, allowing characterization of the behavior of the IED 170 during normal operation.]

FIG. 3B is a schematic block diagram illustrating a system 210 in which IED measurements, merging unit measurements, and/or digitized values are recorded during normal operation. Normal operation of the merging unit 212 may include, for example, receiving electric power delivery system values from a potential transformer 182 and making logic decisions and/or controlling one or more components of the electric power delivery system, such as a circuit breaker, as well as publishing digitized values based on the electric power delivery system values. Normal operation of the IED 108 may include, for example, receiving authentic digitized analog samples 213 of a power delivery system from merging unit 212 and making logic decisions and/or controlling one or more components of the electric power delivery system, such as a circuit breaker, based on the electric power delivery system values. The computing device 230 may, over a specified or determined period of time, record the measurements and/or authentic digitized analog samples 213 it receives from the merging unit 212 and collect records of the internal logic performed by the merging unit 212 and store them in memory. This operation may be performed prior to a settings change (e.g., configuration change) or an update or change to the firmware of the merging unit 212, allowing characterization of the behavior of the merging unit 212 during normal operation.

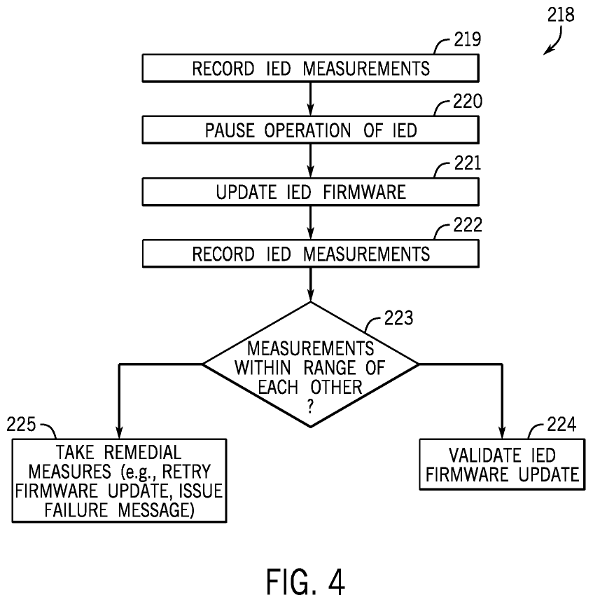

FIG. 3C is a schematic block diagram illustrating the system 210 in which normal communications between the merging unit 212 and an IED 109 are paused, simulated digitized analog samples 215 of a power delivery system are sent to the IED 108, and authentic digital measurements 214 are received from the IED 109. The simulated digitized analog samples 215 may include analog signals that may have similar qualities to the authentic analog signals generated by a current transformer and/or a potential transformer (e.g., the potential transformer 182 and/or the current transformer 184). For example, the simulated digitized values may include analog current values or analog voltage values representative of power system values during nominal or anomalous power system conditions. In other examples, the simulated measurements may include digital values representative of power system values during nominal or anomalous conditions sent to devices that process digital signals rather than analog signals as in FIG. 6c. Thus, the behavior of the relay IED 109 in response to simulated digitized analog samples 215 may be indicative of the behavior of the IED 109 in response to authentic analog data (e.g., during normal operation.)

In some cases, the simulated digitized analog samples 215 may be generated by a testing device. FIG. 3D is a schematic diagram of the system 210, in which the computing device 230 sends a test file 262 to a testing device 260, the testing device 260 generates the simulated digitized analog samples 215, and the testing device 260 sends the simulated digitized analog samples 215 (e.g., current, voltage, etc.) of the electric power delivery system to the IED 109. The IED 109 may then generate simulated digital measurements 264 and may send the simulated digital measurements 264 to the testing device 260, and the testing device 260 may forward the simulated digital measurements 264 to the computing device 230. As mentioned, the simulated digitized analog samples 215 may include analog signals that may have similar qualities to the authentic analog signals generated by a current transformer and/or a potential transformer (e.g., the potential transformer 182 and/or the current transformer 184).

Additionally or alternatively, an IED may be connected directly to a potential transformer and/or current transformer and may receive simulated analog power system values from a testing device. FIG. 3E is a schematic diagram of the system 210, in which normal operation of the IED 108 connected to the potential transformer 182 and the current transformer 184 is paused, the testing device 260 generates simulated digitized analog samples 299 based on the test file 262 and sends the simulated digitized analog samples 299 to the IED 108, and the IED 108 generates simulated digital measurements 264 based on the simulated digitized analog samples 299. The IED 108 may send the simulated digital measurements 264 to the testing device 260, and the testing device 260 may forward the simulated digital measurements 264 to the computing device 230. Normal operation of the IED 108 may include receiving analog values (e.g., currents, voltages, and the like) from the potential transformer 182 and/or the current transformer 184. Thus, the simulated digitized analog samples 299 may include analog signals that may have similar qualities to the authentic analog signals generated by a current transformer and/or a potential transformer (e.g., the potential transformer 182 and/or the current transformer 184).

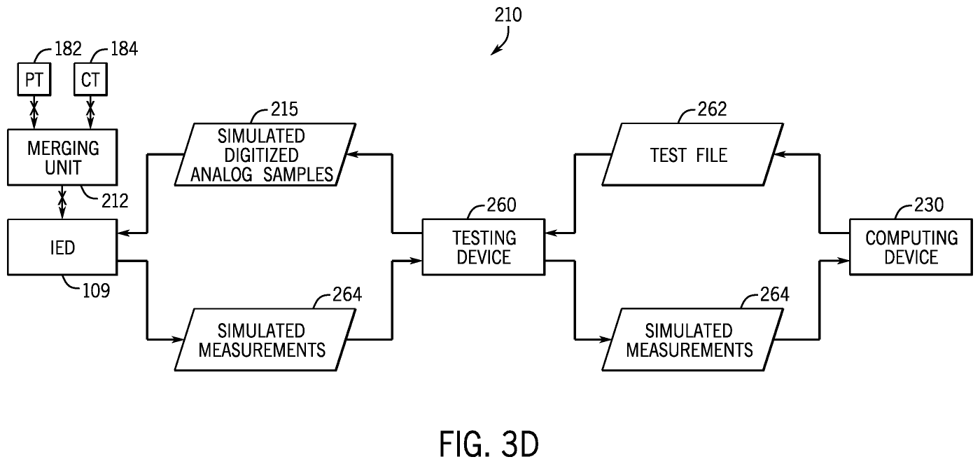

FIG. 4 is a flowchart of a method 218 for validating electric power delivery system settings and/or firmware using IED measurements recorded before and after a settings (e.g, configuration) or firmware change. It should be noted that while the method 218 is described as being performed for an IED, in some examples, the method 218 may be performed for a merging unit (e.g., the merging unit 212). In process block 219, IED measurements are recorded during prior to a configuration or firmware update to produce first measurements (e.g., internal logic results) of the IED 108 and/or IED 170 and or merging unit 212 that are stored in the memory of the computing device 230. In process block 220, normal operation of the IED is paused. In process block 220, IED settings or firmware are updated using a computing device that may be communicatively coupled to the IED via electrical connection, local area network, wide area network, and so on. The settings or firmware update may cause configuration changes associated with the function of the IED, e.g. security validation changes, control function changes, and so forth. In process block 222, measurements from the IED 108 and/or IED 170 and or merging unit 212 are recorded after a firmware update to produce second measurements that are stored in the memory of the computing device.

In query block 223, the first measurements (e.g., internal logic results of the IED 108 and/or IED 170 and/or merging unit 212 recorded prior to the settings and firmware change are compared to the second measurements recorded after a settings or firmware update. If the second measurements are within a specified or determined range of the first measurements, in process block 224, the IED settings and firmware update is validated. If, however, the second measurements are not within range of the first measurements, in process block 225, remedial measures are taken. Remedial measures may include, for example, an automatic restart of the firmware update process, a failure message being displayed to the display of the computing device, and so forth.

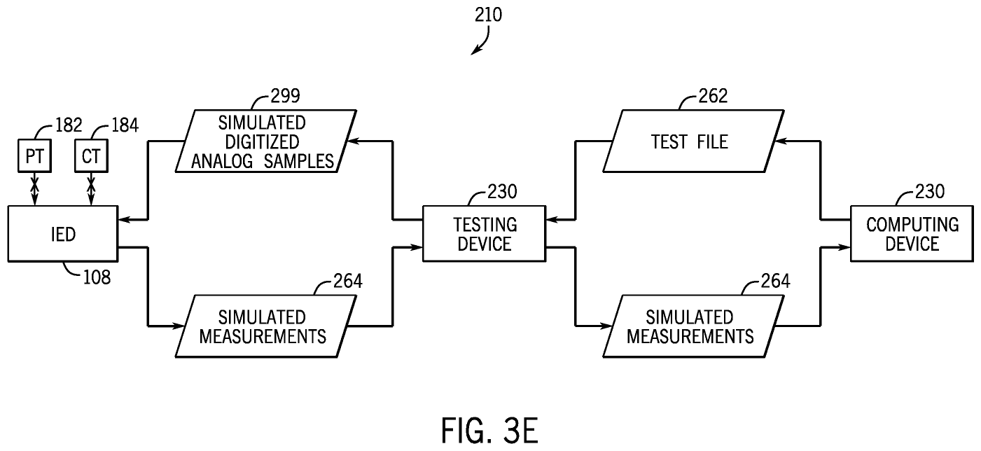

FIG. 5 is a schematic diagram illustrating the system 210, in which operation of the IED 108 and/or the merging unit 212 is paused and settings or firmware of the IED 108 and/or the merging unit 212 is updated. The system 210 may perform or be used in conjunction with process blocks 220 and 221 of the method 218. In the illustrated example, transmission of electric power delivery system measurements from the potential transformer 182 and the current transformer 184 is paused. In some embodiments, a command from computing device 230 may decouple the merging unit 212 from the potential transformer 182 and the current transformer 184, allowing a pause of processing authentic power system values while obviating the need for intervention at the potential transformer 182 or the current transformer 184. In some embodiments, a switch may decouple the IED 170 from the authentic digital measurements 214 from IED 108, allowing a pause of transmission while obviating the need for intervention at the IED 108 or IED 170.

In another example, the computing device 230 may use a software-defined-network (SDN) to manage the communicative connections between I IED 108, publishing digitized messages representing signals from potential transformers 182, current transformers 184, and IED 170 and computing devices 230. The SDN packet flow rules may control the flow of data, including settings commands, records of internal IED logic, firmware updates, simulated measurements, and test results between merging units 212, IEDs 108, and computing devices 230. The parameters of the SDN flow rules may be adjusted by an operator remotely or on-site at the computing device 230 (e.g., via the UI of the computing device 230). Further, the SDN flow rules managed by the computing device 230 may control the flow of data for a specified or determined time. For example, the SDN may allow (e.g., turn on) specific settings and firmware change command data flow from the computing device to the IED 108 during setting and firmware update and validation testing, and pause (e.g., turn off) settings and firmware change command data flow from the computing device 230 to the IED 108 to resume normal electric power delivery system operation and other unique data flow.

With communication of the digitized signals between the merging unit, and the IED 108, or communication of the digitized signals between IED 108 and IED 170 paused and communication between the computing device 230 and the IED 108 and or IED 170 established, a firmware update 232 is sent to the IED 108 and/or IED 170. In some examples, the IED 108 and or IED 170 may receive the firmware update 232 from a computing device other than the computing device 230. The firmware update 232 may comprise a data signal indicative of instructions to be stored (e.g., downloaded) in the memory and executed by the processor of the

IED 108 and/or IED 170. The instructions may include, for example, security (e.g., cybersecurity) configuration changes, measurement changes, user validation configuration changes, control function changes, and so forth. The instructions may also include instructions to enter an update mode or test mode, in which the IED 108 and/or IED 170 receives inputs and generates test results indicative of the functional outputs the IED 108 and/or IED 170 outputs during normal operation. For example, the IED 108 and/or IED 170 may provide an indication of behavior in response to input without transmitting an output capable of functional operation (e.g., tripping a circuit breaker), so that the behavior of the IED 108 and/or IED 170 during firmware update and validation testing does not impact the electric power delivery system the IED 108 and/or IED 170 is connected to and/or part of. Upon completion of the IED firmware update, the IED 108 and/or IED 170 may send an indication to the computing device that the firmware update is complete.

FIG. 6 is a schematic diagram illustrating the system 210, in which measurements (e.g., internal logic results) are obtained from the IED 108 after a settings or firmware update, as described in process block 222 of the method 218. In the illustrated embodiment, the IED 108 may receive electric power delivery system values from the potential transformer 182 and the current transformer 184 following an update to the settings or firmware of the IED 108, as described above. The IED 108 may convert the received power system values to digital data and transmit the digital data to a computing device 230 as authentic digital measurements 240. The computing device 230 may, over a specified or determined period of time, record the authentic digital measurements 214 it receives from the IED 108 and store them in memory and/or request and store records of internal IED logic. As mentioned, the instructions sent to the IED 108 as part of or in conjunction with the setting or firmware update may include instructions to enter a test mode, such that the behavior of the IED 108 in response to receiving power system values does not cause a functional change to the power delivery system, such as tripping a circuit breaker. It should be understood that, in some examples, the authentic digital measurements 240 may be generated based on digitized power system values received from a merging unit (e.g., as illustrated in FIG. 3B) or simulated analog power system values (as illustrated in FIG. 3C). Additionally or alternatively, the authentic digital measurements 240 may be received directly from a merging unit as digitized power system values, as illustrated in FIG. 3C.

After records of internal IED logic or digitized power system values are obtained from the IED after a settings or firmware update, the second records of internal IED logic values and measurements (i.e., the IED logic values and measurements recorded before the setting or firmware update) are compared to the first measurements (i.e., the IED logic values and measurements recorded after the setting or firmware update) to determine whether the second records of internal IED logic and measurements are within a validation range (e.g., threshold) of the first measurements. Each of the first records of internal IED logic and measurements and second records of internal IED logic and measurements may include, for example, values and/or measurements received by the IED 108 prior to performing a control function, control functions performed by the IED 108 based on the received power system values, measurements determined by the IED 108 after a control function is performed, time between measurements, event reports, and so forth. The determined or specified range may be automatically determined by the computing device or the IED or specified by the operator of the computing device at the UI of the computing device. In some embodiments, the determined or specified range may include a percentage of the IED measurements during normal operation. For example, the determined or specified range may be specified by the operator as 1%, 5%, 10%, or 20% of the IED measurements recorded during normal operation. If the first records of internal IED logic and measurements are within the determined or specified range of the second records of internal IED logic and measurements, the IED settings and firmware update is validated. In response to validation of the IED setting and firmware update, the computing device 230 may present a message 244 to the operator of the computing device 230 confirming that the setting and firmware update has been validated.

If, however, the first measurements are not within the determined or specified validation range of the second measurements, the IED settings and firmware is invalidated. In response, the computing device 230 may execute remedial measures. Remedial measures include, for example, sending a signal to the IED 108 indicative of instructions to restart the firmware update process or revert to a prior firmware configuration. Remedial measures may also include displaying a message to the display of the computing device 230 indicating that IED setting and firmware update validation failed. In some embodiments, the computing device 230 may execute remedial measures based in part by operator input. For example, a message may be presented to the operator of the computing device including a notification that setting or firmware update validation failed. The operator may then select an option, via the UI of the computing device 230, to restart the IED 108 setting or firmware update process. The computing device 230 then sends a signal to the IED 108 indicative of instructions to restart the setting or firmware update process.

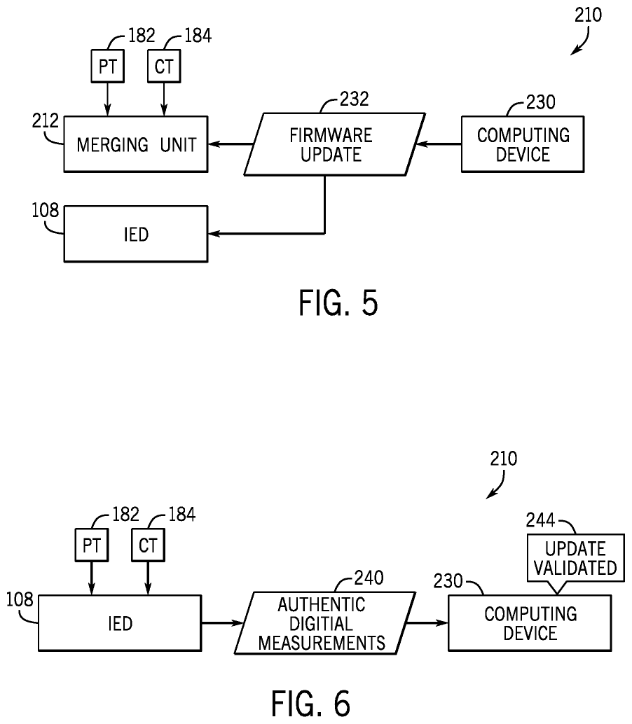

FIG. 7 is a schematic diagram of the system 210, in which a remote computing device 250 initiates (e.g., prompts) a setting or firmware update of the IED 108 via wide-area network (WAN) 252 and computing device 230. It should be understood that a similar process may be performed to initiate a setting or firmware update of a merging unit (e.g., the merging unit 212).

In one particular example, the computing device 230 may store multiple settings files (e.g., settings changes) and firmware updates in memory. Each of the multiple settings files and firmware updates may have varying configuration changes. The remote computing device 250 may accept operator input, via UI input or other input mechanism, to select a setting file or firmware update 232 of the multiple settings files and firmware updates. In other examples, a settings file or firmware update may be selected by an automatic process, such as a scheduled maintenance process. In either case, the remote computing device 250 may send a signal 232 via WAN 252 to the computing device 230 indicative of instructions to update the IED 108 using the selected settings file or firmware update 232. In response, the computing device 230 may send a signal indicative of the settings file or firmware update 232 to the IED 108, as described in process blocks 220 and 221 of the method 218 of FIG. 4. As such, the methods described herein for IED settings or firmware validation may be performed by a computing device that is separated (e.g., remote) from an IED via, for example, a wide area network.

A firmware update of the multiple firmware updates stored in the memory of the computing device 230 may be selected based on a desired IED configuration change(s). For example, the computing device may store a first settings file or firmware update that changes a security configuration of the IED 108 and a second settings file or firmware update that changes a control function configuration of the IED 108. If an operator of the remote computing device 250 selects the first settings file or firmware update, the remote computing device 250 sends a signal 232 via WAN 252 indicative of instructions to update the IED 108 using the first settings file or firmware update. Likewise, if the operator selects the second settings file or firmware update, the remote computing device 250 sends a signal 232 via WAN 252 indicative of instructions to update the IED 108 using the second settings file or firmware update. Indeed, by selecting a settings file or firmware update stored locally on the computing device 230, IED settings file or firmware updates may be initiated remotely without the need for transmission of the settings file or firmware update contents over WAN 252 or other communication networks. Thus, the contents of firmware update 232 may be protected from security threats from WAN 252. Further, commands sent from the remote computing device 250 to the computing device 230 via WAN 252 may be protected using any suitable form of encryption (e.g., MACsec, AES, DES, etc.).

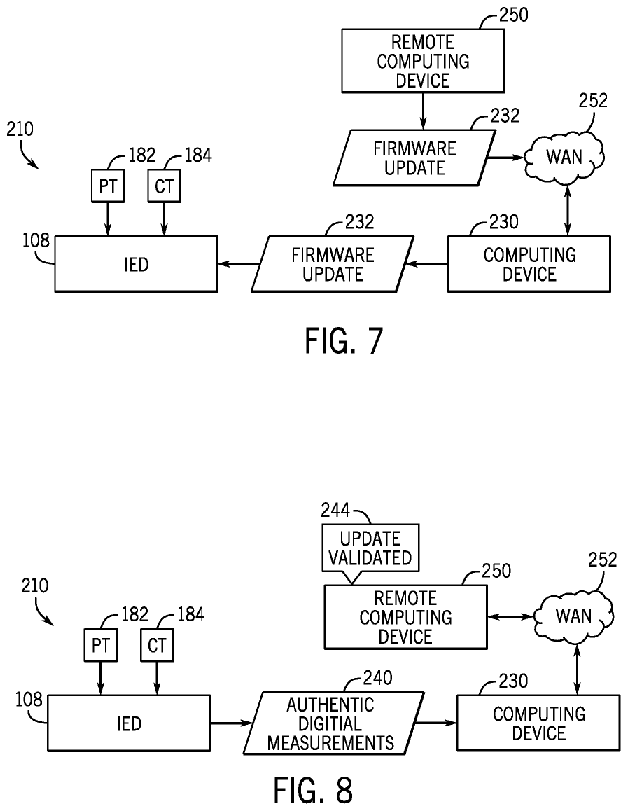

FIG. 8 is a schematic diagram of the system 210, in which a remote computing device 250 remotely initiates the validation process of a settings file or firmware update of the IED 108. The remote computing device 250 may initiate the validation process automatically or upon input from an operator of the remote computing device 250. For example, the remote computing device 250 may initiate the validation process before initiating a settings file or firmware update, after receiving indication that a settings file or firmware update is complete, after an amount of time has elapsed since initiation of a settings file or firmware update, or as part of an automatic (e.g., periodic) maintenance process. As such, the computing device 230 may act as an edge device (e.g., proxy device) for communications between the remote computing device 250 and, for example, the IED 108. It should be understood that, in some examples, the authentic digital measurements 240 may be generated based on digitized power system values received from a merging unit (e.g., as illustrated in FIG. 3B) or simulated analog power system values (as illustrated in FIG. 3C). Additionally or alternatively, the authentic digital measurements 240 may be received directly from a merging unit as digitized power system values, as illustrated in FIG. 3C.

In an embodiment, the authentic digital measurements 240 representing first measurements (i.e., IED internal logic results and measurements before a settings file or firmware update to the IED 108) and second measurements (i.e., IED internal logic results and measurements recorded after a settings file or firmware update to the IED 108) are sent to the computing device 230. In response, the computing device 230 compares the second measurements to the first measurements, as generally described with respect to block 223 of the method 218. If the second measurements are within a validation range of the first measurements, the remote computing device 230 validates the settings file or firmware update, and may send a signal via WAN 252 to the remote computing device 250 indicative of the settings file or firmware update validation. In response to receiving the signal indicative of the settings file or firmware update validation, the remote computing device 250 may present a message 244 to the operator of the computing device 250 (e.g., via the display of the computing device 250) confirming that the IED settings file or firmware update is validated.

If, however, the settings file or firmware update is invalidated, the computing device 230 may send a signal via WAN 252 to the remote computing device 250 indicative of the settings file or firmware update invalidation. In response to receiving the signal indicative of settings file or firmware update invalidation, the remote computing device 250 may take remedial measures as described above and illustrated by the process block 224 of the method 218.

In an example, the authentic digital measurements 240 representing first measurements (i.e., IED internal logic results and measurements before a settings file or firmware update to the IED 108) and second measurements (i.e., IED internal logic results and measurements recorded after a settings file or firmware update to the IED 108) are sent to the remote computing device 250 via computing device 230 and WAN 252. In response, the remote computing device 250 compares the second measurements to the first measurements, as generally described by block 223 of the method 218. As described above, if the second measurements are within a validation range of the first measurements, the remote computing device 250 validates the settings file or firmware update. If, however, the sets of measurements are not within range of each other (e.g., within some expected threshold), remedial measures are taken.

The computing device 230 may store in memory a log of test results, event reports, internal logic results, or measurements received over a period of time or settings file and firmware update validations processes. This log may be accessed and viewed by an operator of the computing device 230 via the display and/or UI. Further, the remote computing device 250 may query the computing device 230 for the log via the WAN 252. In response, the computing device 230 may transmit a signal over WAN 252 to the remote computing device 250 indicative of the log. In response, the remote computing device 250 may store the log in memory, such that it can be accessed by an operator of the remote computing device 250 via the display or UI. Thus, by retrieving the log, an operator of the remote computing device 250 may remotely view information indicating the behavior of the IED(s) communicatively connected to the computing device 230. This allows, for example, a regulatory audit of the electric power delivery system to be conducted without the need for an operator to be physically present at the electric power delivery system.

In one example, the WAN 252 communicatively may couple the remote computing device 250 and multiple computing devices 230. In some examples, the multiple computing devices 230 may be deployed as part of, or in conjunction with, multiple electric power delivery systems. A remote computing device 250 may thus initiate and validate firmware updates of one or more IEDs 108 via the multiple computing devices 230 and the WAN 252. Thus, via the remote computing device 250, an operator may remotely push a firmware update to a large number of IEDs 108. Likewise, the remote computing device 250 may query the one or more computing device(s) 230 for a log of event reports, test results, and so on, of the multiple IEDs 108 fulfill, for example, a provider-wide or system-wide regulatory audit. In one example, after pushing a settings file or firmware update to multiple IEDs 108, upon determination of an invalid settings file or firmware update for one or more IEDs 108, remedial measures may be taken for all IEDs 108 that received the firmware update. In other words, if a problem with a settings file or firmware update is detected at one IED 108, the settings file or firmware update may be restarted, rolled back, reset, or otherwise remedied across all IEDs 108 that received the update.

While specific embodiments and applications of the disclosure have been illustrated and described, it is to be noted that the disclosure is not limited to the precise configurations and devices disclosed herein. Accordingly, many changes may be made to the details of the above-described embodiments without departing from the underlying principles of this disclosure. The scope of the present disclosure should, therefore, be determined only by the following claims.

Indeed, the embodiments set forth in the present disclosure may be susceptible to various modifications and alternative forms, specific embodiments have been shown by way of example in the drawings and have been described in detail herein. However, it may be noted that the disclosure is not intended to be limited to the particular forms disclosed. The disclosure is to cover all modifications, equivalents, and alternatives falling within the spirit and scope of the disclosure as defined by the following appended claims. In addition, the techniques presented and claimed herein are referenced and applied to material objects and concrete examples of a practical nature that demonstrably improve the present technical field and, as such, are not abstract, intangible or purely theoretical. Further, if any claims appended to the end of this specification contain one or more elements designated as “means for [perform] ing [a function] . . . ” or “step for [perform]ing [a function] . . . ”, it is intended that such elements are to be interpreted under 35 U.S.C. 112(f). For any claims containing elements designated in any other manner, however, it is intended that such elements are not to be interpreted under 35 U.S.C. 112(f).

What is claimed is:

1. A system, comprising;
a computing device communicatively coupled to an intelligent electronic device (IED) of an electric power delivery system, wherein the computing device is configured to:
receive a first signal indicative of first measurements from the intelligent electronic device (IED);
transmit a second signal indicative of instructions to pause normal intelligent electronic device (IED) operation and apply a settings change or firmware update;
receive a third signal indicative of second measurements from the intelligent electronic device (IED); and
determine validation of the settings or firmware update based on the first measurements and the second measurements.

2. The system of claim 1, wherein the first measurements comprise first internal logic results and the second measurements comprise second internal logic results, and wherein the computing device is configured to determine validation of the settings change or firmware update based on a comparison of the first measurements and second measurements.

3. The system of claim 2, wherein the computing device is configured to determine that the settings change or firmware update is validated when the second measurements fall within a threshold of the first measurements.

4. The system of claim 1, wherein the computing device is configured to send the settings change or firmware update to the intelligent electronic device (IED) before transmitting the signal indicative of instructions to pause normal intelligent electronic device (IED) operation and apply the settings change or firmware update.

5. The system of claim 1, wherein the intelligent electronic device generates the first measurements and second measurements based on electric power delivery system values.

6. The system of claim 1, wherein the first measurements and second measurements are generated by the intelligent electronic device IED, the second measurements being generated after the first measurements are generated.

7. The system of claim 6, wherein the intelligent electronic device (IED) applies the settings change or firmware update after generating the first measurements and before generating the second measurements.

8. The system of claim 7, wherein the intelligent electronic device (IED) is configured to download the settings change or firmware update from a source other than the computing device.

9. The system of claim 7, wherein the intelligent electronic device (IED) is configured to pause normal intelligent electronic device (IED) operation in response to the instructions to pause normal intelligent electronic device (IED) operation, wherein the intelligent electronic device (IED) is configured to control one or more components of the electric power delivery system during normal intelligent electronic device (IED) operation and not to control the one or more components of the electric power delivery system when normal intelligent electronic device (IED) operation is paused.

10. The system of claim 1, wherein:
the computing device comprises a remote computing device;
the system comprises a local computing device in communication with the intelligent electronic device (IED); and
the remote computing device is configured to communicatively couple, via a wide area network, to the local computing device in communication with the intelligent electronic device (IED) to enable the remote computing device to communicatively couple to the intelligent electronic device (IED).

11. A non-transitory computer-readable medium comprising computer-executable instructions that, when executed, are configured to cause data processing circuitry to perform operations comprising:
receiving first measurements from an intelligent electronic device (IED);
issuing one or more commands to an intelligent electronic device (IED) to pause normal intelligent electronic device (IED) operation and apply a settings change or firmware update;
receiving second measurements from the intelligent electronic device (IED); and
determining validation of the settings change or firmware update based on the first measurements and second measurements.

12. The computer-readable medium of claim 11, wherein the first measurements comprise first internal logic results generated before the settings change or firmware update is applied, and wherein the second measurements comprise second internal logic results generated after the settings change or firmware update is applied.

13. The computer-readable medium of claim 11, comprising instructions that, when executed, are configured to cause the data processing circuitry to perform operations comprising:
providing the firmware update to the intelligent electronic device (IED).

14. The computer-readable medium of claim 11, comprising instructions that, when executed, are configured to cause the data processing circuitry to perform operations comprising:
issuing one or more commands to the intelligent electronic device (IED) to download the settings change or firmware update.

15. The computer-readable medium of claim 11, comprising instructions that, when executed, are configured to cause the data processing circuitry to perform operations comprising:
connecting, via a wide area network, to a local computing system; and
prompting the local computing system to perform the operations recited in claim 11.

16. The computer-readable medium of claim 11, comprising instructions that, when executed, are configured to cause the data processing circuitry to perform operations comprising:
connecting, via a wide area network, to a local computing system; and
performing the operations recited in claim 11 using the local computing system as an edge device.

17. A method, comprising:
receiving, via a computing device, first measurements from an intelligent electronic device (IED) of a power delivery system;
instructing, via a computing device, the intelligent electronic device (IED) to pause normal operation and apply a settings change or firmware update;
receiving, via the computing device, second measurements from the intelligent electronic device (IED); and
determining, via the computing device, validation of the settings change or firmware update based on the first measurements and second measurements.

18. The method of claim 17, wherein the settings change or firmware update comprises security configuration changes, control changes, measurement changes, internal logic results, or any combination thereof.

19. The method of claim 17, wherein the method is performed by a computing device within a local area network of the intelligent electronic device (IED).

20. The method of claim 17, wherein the method is performed by a computing device separated from the intelligent electronic device (IED) by a wide area network.
